(19) United States
(12) Patent Application Publication
(10) Pub. No.: US 2009/0152894 A1
(43) Pub. Date: Jun. 18, 2009

(54) STRUCTURE OF MOUNTING GARNISH TO DOOR FRAME OF VEHICLE

(75) Inventor: Bumsuk Kang, Hwaseong-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/132,803

(22) Filed: Jun. 4, 2008

(30) Foreign Application Priority Data
Dec. 15, 2007 (KR) 10-2007-0131794

(51) Int. Cl. B60J 10/08

(52) U.S. Cl. 296/146.9; 296/146.5

(57) ABSTRACT

A garnish to be mounted to a door frame of a vehicle, and a mounting structure thereof. The garnish has a mounting boss, a first end, and a second end. The mounting structure includes a door frame with a space for the mounting boss of the garnish to be inserted therein and secured by a fastener. The mounting structure also includes a glass run channel with an edge that contacts an outer end of the door frame. The first end of the garnish is shaped to be fitted into an edge of the glass run channel. The second end of the garnish has a protrusion shaped to cover an end of the door frame. The glass run channel may have a clearance groove to prevent interference with the fastener. The fastener may be a screw. Double-sided tape may be provided for further securing the garnish to the door frame.

### CROSS-REFERENCE TO RELATED APPLICATIONS

The present application is based on, and claims priority from, Korean Application Serial Number 10-2007-0131794, filed on Dec. 15, 2007, the disclosure of which is hereby incorporated by reference herein in its entirety.

### FIELD OF THE INVENTION

The present invention relates to a structure of mounting a garnish to a door frame of a vehicle.

### BACKGROUND OF THE INVENTION

It is preferable that taxies and rental cars do not include garnishes, to save cost, and that common cars do include garnishes, to benefit appearance. Therefore, a structure should be provided in which a garnish may or may not be mounted to a door frame.

A typical garnish is mounted to a door frame with upper and lower mounting clips and double-sided tape. The mounting clips are fitted in mounting holes in door frame, and an end of the garnish is fitted in a gap between a glass run channel and the door frame. A weather strip joint covers the mounting clips. A silicon coating is applied on the surface of the weather strip joint to improve the appearance and prevent change of color. When a garnish is not mounted to this structure, there is a gap between the glass run channel and the door frame.

The above information disclosed in this Background section is only for enhancement of understanding of the background of the invention and therefore it may contain information that does not form the prior art that is already known in this country to a person of ordinary skill in the art.

### SUMMARY OF THE INVENTION

A garnish to be mounted to a door frame of a vehicle, and a mounting structure thereof. The garnish has a mounting boss, a first end, and a second end. The mounting structure includes a door frame with a space for the mounting boss of the garnish to be inserted therein and secured by a fastener. The mounting structure also includes a glass run channel with an edge that contacts an outer end of the door frame. The first end of the garnish is shaped to be fitted into an edge of the glass run channel. The second end of the garnish has a protrusion shaped to cover an end of the door frame.

The glass run channel may have a clearance groove to prevent interference with the fastener. The fastener may be a screw. Double-sided tape may be provided for further securing the garnish to the door frame.

### BRIEF DESCRIPTION OF THE DRAWINGS

For better understanding of the nature and objects of the present invention, reference should be made to the following detailed description with the accompanying drawings, in which:

FIG. 1 is a cross-sectional view of a structure of mounting a garnish to a door frame of a vehicle according to an embodiment of the invention, in which a garnish has been mounted; and

FIG. 2 is a cross-sectional view of the structure of FIG. 1, in which a garnish is not mounted.

### DETAILED DESCRIPTION OF THE PREFERRED EMBODIMENTS

A garnish 1 has therein a mounting boss 5 protruding toward a door frame 3. The door frame 3 has a space 7 in which the mounting boss 5 is inserted. A screw 13 extends through a run channel groove 11 between a glass run channel 9 and the door frame 3, in order to fix mounting boss 5 to door frame 3. A clearance groove 23 is provided on glass run channel 9 to prevent interference with the head of screw 13. Glass run channel 9 has an edge 15 that contacts the outer end of door frame 3. Furthermore, garnish 1 has a first end 17 that is shaped to be fitted to edge 15 of glass run channel 9, and a second end 19 having a protrusion formed to cover an end of door frame 3.

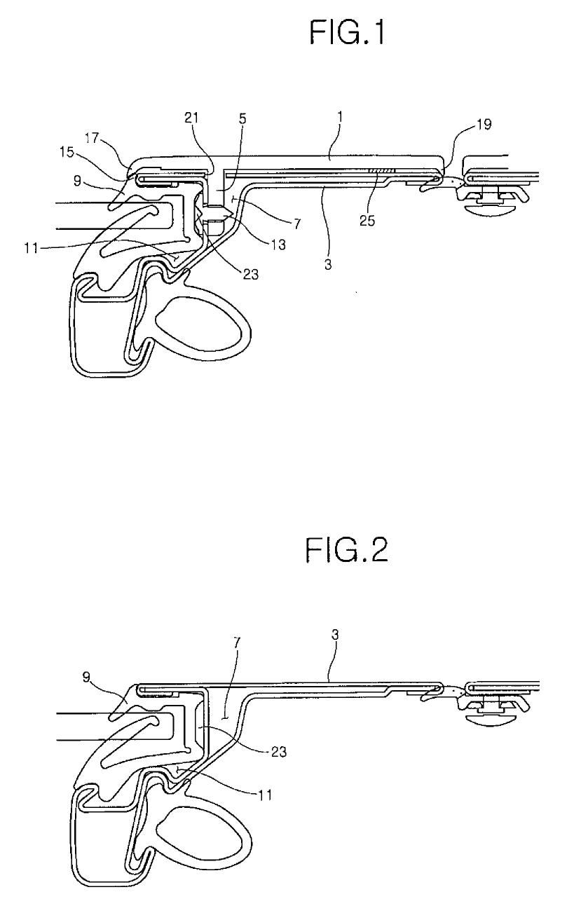

Garnish 1 may be or may not be mounted to door frame 3. If a garnish 1 is to be provided, a mounting hole 21 for inserting mounting boss 5 is provided through door frame 3 (FIG. 1). If a garnish 1 is not to be mounted, there is no mounting hole 21 (FIG. 2). This does not practically change the appearance of door frame 3.

Screw 13 secures mounting boss 5, without the need for a weather strip joint to cover mounting clips inside door frame 3, as in the prior art. That is, mounting boss 5 cannot be seen from the inside of door frame 3. Therefore, double-sided tape and silicon coating are also not needed, which reduces the manufacturing cost of the vehicle.

Further, since edge 15 of glass run channel 9 contacts the outer end of door frame 3 even if no garnish 1 is provided, there is no gap between glass run channel 9 and door frame 3. Further, since end 17 of garnish 1 has the shape corresponding to edge 15 and the joint of them is rounded, a smooth appearance is obtained if garnish 1 is mounted.

Further, the protrusion at end 19 of garnish 1 covers the end of door frame 3, further improving the appearance.

Garnish 1 may be thin, such that the outer width of door frame 3 is unaffected by the presence or absence of garnish 1.

Garnish 1 may be further secured to door frame 3 by double-sided tape 25.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A mounting structure of a garnish for a vehicle, comprising:
a door frame comprising a space configured for a mounting boss of the garnish to be inserted therein; and
a glass run channel comprising an edge that contacts an outer end of the door frame.

2. A garnish configured to be mounted to a door frame of a vehicle, comprising:
a mounting boss configured to be inserted in a space in the door frame and secured therein by a fastener;
a first end configured to be fitted into an edge of a glass run channel; and
a second end comprising a protrusion configured to cover an end of the door frame.

3. The garnish of claim 2, wherein the fastener comprises a screw.

4. A combination of a garnish configured to be mounted to a door frame of a vehicle and a mounting structure thereof,
wherein the garnish comprises a mounting boss, a first end, and a second end;
wherein the mounting structure comprises a door frame comprising a space configured for the mounting boss of the garnish to be inserted therein and secured by a fastener, and a glass run channel comprising an edge that contacts an outer end of the door frame;
wherein the first end of the garnish is configured to be fitted into an edge of the glass run channel;
and wherein the second end of the garnish comprises a protrusion configured to cover an end of the door frame.

5. The combination of claim 4, wherein the glass run channel comprises a clearance groove to prevent interference with the fastener.

6. The combination of claim 4, wherein the fastener comprises a screw.

7. The combination of claim 4, further comprising double-sided tape for securing the garnish to the door frame.
